(19) United States
(12) Patent Application Publication
(10) Pub. No.: US 2013/0317316 A1
(43) Pub. Date: Nov. 28, 2013

(54) CARBOHYDRATE MODELING METHODS, SYSTEMS, AND DEVICES

(71) Applicant: CITY OF HOPE, Duarte, CA (US)

(72) Inventor: Fouad KANDEEL, La Palma, CA (US)

(21) Appl. No.: 13/903,959

(22) Filed: May 28, 2013

Related U.S. Application Data
(60) Provisional application No. 61/651,957, filed on May 25, 2012.

(51) Int. Cl. G06F 19/00

(52) U.S. Cl. CPC G06F 19/3487
USPC 600/300

(57) ABSTRACT

The present application provides novel methods and devices for carbohydrate monitoring and diabetes treatment.

### RELATED APPLICATIONS

The present application claims priority to U.S. Provisional Application No. 61/651,957, filed May 25, 2012 and entitled “Carbohydrate Modeling Methods, Systems, and Devices,” the disclosure of which is incorporated by reference herein in its entirety.

### BACKGROUND

Diabetes mellitus is one of the most serious global health threats of the modern era. In 2010, diabetes mellitus affected 285 million people worldwide. If current trends continue, 438 million people will have diabetes by 2030. As a well-established risk factor for heart disease, stroke, and kidney failure, diabetes-related deaths will also double between 2005 and 2030. With as many as half of all diabetic patients remaining undiagnosed, these already sizable figures are likely gross underestimations. Longer term projections are even worse, for example, the Center for Disease Control (CDC) has recently estimated that 76 million American (one out of every 3 peoples) will have diabetes by 2050, and these estimates will hold-up even if obesity rates remain static. Such high estimates of future disease incidence suggest that cost of care for diabetes will overwhelm if not bankrupt the American health care system. The outlook is even worse in many other countries. More than 50% of the world's expenditure on diabetes care occurs in the United States, and the anticipated rates of increase in disease incidence are much less than in lower-income countries, where 70% of diabetics currently reside. These lower-income countries also have inadequate health care systems. Moreover, 46% of diabetics worldwide are of working age (40-59 years) and the disease is increasingly occurring at an earlier age, suggesting that the cost of treating diabetes and its complications over the life span of affected individuals together with the loss in their productivity will overwhelm world economy.

Attempts to improve long-term therapeutic outcomes for patients have been largely ineffective due to the inconsistent implementation of standards of care for diabetes, inefficient healthcare delivery systems, inadequate numbers of trained physicians, and a general lack of financial resources in many parts of the world, and are frequently confounded by a lack of patient compliance and reliable long-term outcome data, particularly within and among countries. Thus, there is a critical need for a cost-effective solution to simplify diabetes management, minimize physician time/effort spent on expensive and unstructured treatment plans, and simultaneously improve patient acceptance of behavioral modification and therapeutic drug regimens that can be applied on a global scale.

### SUMMARY

Provided herein in certain embodiments are methods for the control and treatment of diabetes in a subject in need thereof. In these embodiments, one or more pieces of input health data such as dietary data, physical activity data, or drug intake data are entered into a computer system by the subject or by a physician or other healthcare provider. This input data is converted to output health data, either on the computer system or at a remote location to which the computer system is connected. In certain embodiments, the input data is converted to output data using KADIS and/or ADAMS. In certain embodiments, the computer system is a mobile device, and in certain of these embodiments the mobile device is connected to the remote location wirelessly. The output health data is then displayed on the computer system, providing the subject and/or the physician or other healthcare provider with information, feedback, and recommendations regarding various health parameters. In certain embodiments, the output health data provides recommendations regarding diabetes management, including for example dietary choices, physical activity choices, and/or drug intake choices.

### BRIEF DESCRIPTION OF DRAWINGS

FIG. 1: Data flow architecture for the ADAMS system.

FIG. 2: ADAMS front end application architecture (view 1).

FIG. 3: ADAMS user interface.

FIG. 4: ADAMS front end application architecture (view 2).

FIG. 5: ADAMS front end application architecture (view 3).

FIG. 6: Sample ADAMS screenshot for energy expenditure recommendations.

FIG. 7: Sample ADAMS screenshot for calorie recommendations.

FIG. 8: Sample ADAMS screenshot for exercise recommendations.

FIG. 9: Sample ADAMS decision tree for drug and exercise recommendations.

FIG. 10: Sample ADAMS decision tree for drug and exercise recommendations.

FIG. 11: Study outline.

FIG. 12: Flowchart for calculating baseline energy expenditure.

FIG. 13: Baseline dietary and physical activity assessment.

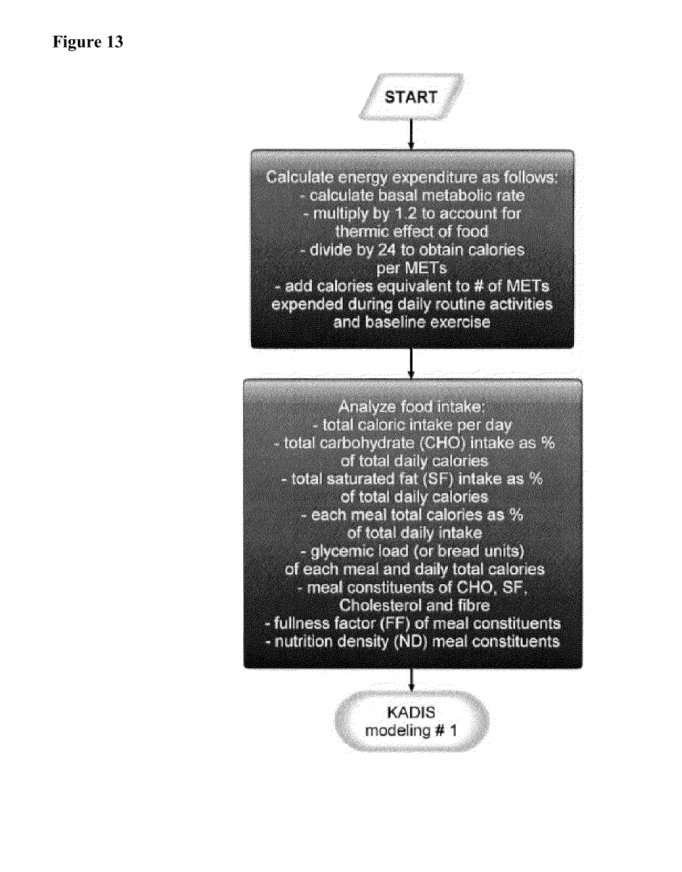

FIG. 14: Optimization of physical activity algorithm.

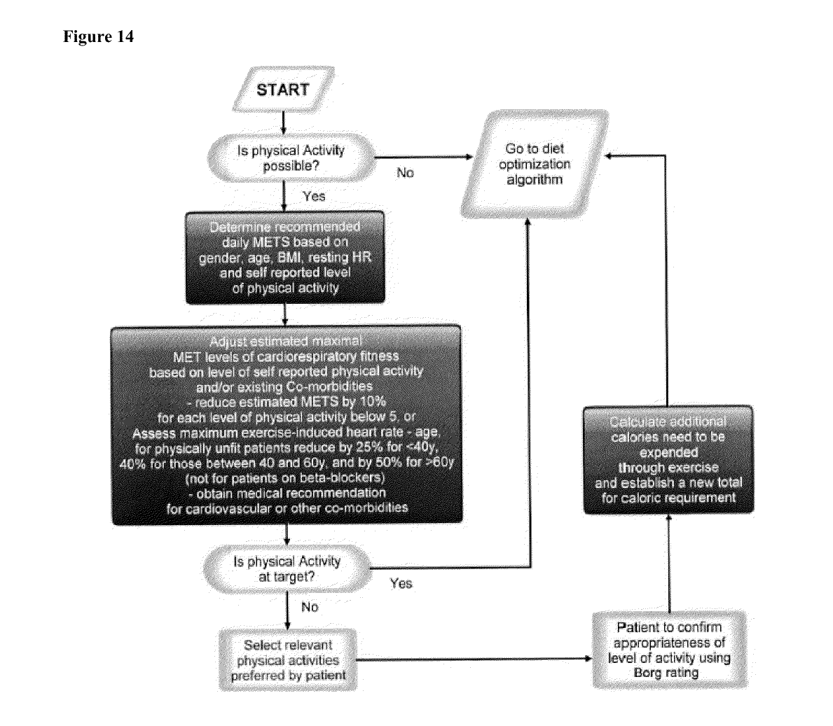

FIG. 15: Optimization of diet algorithm.

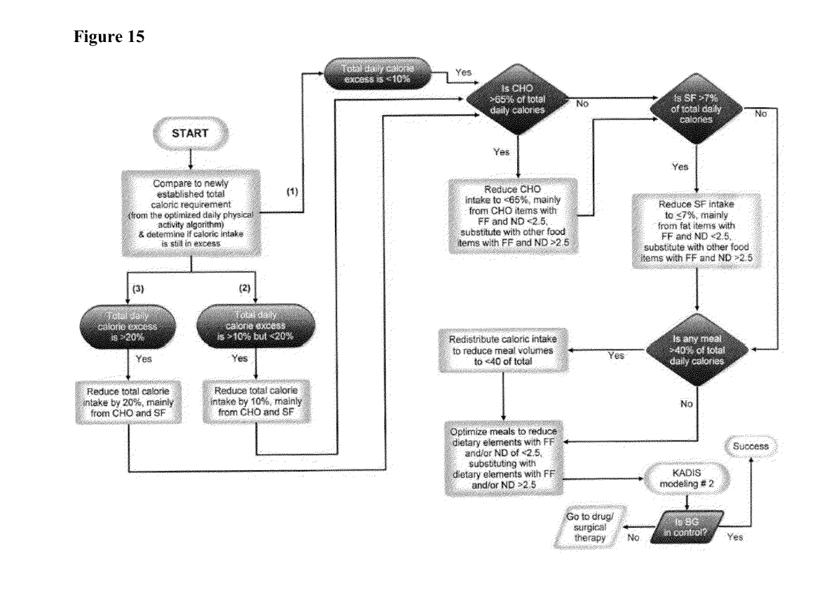

FIG. 16: Sulfonylurea algorithm.

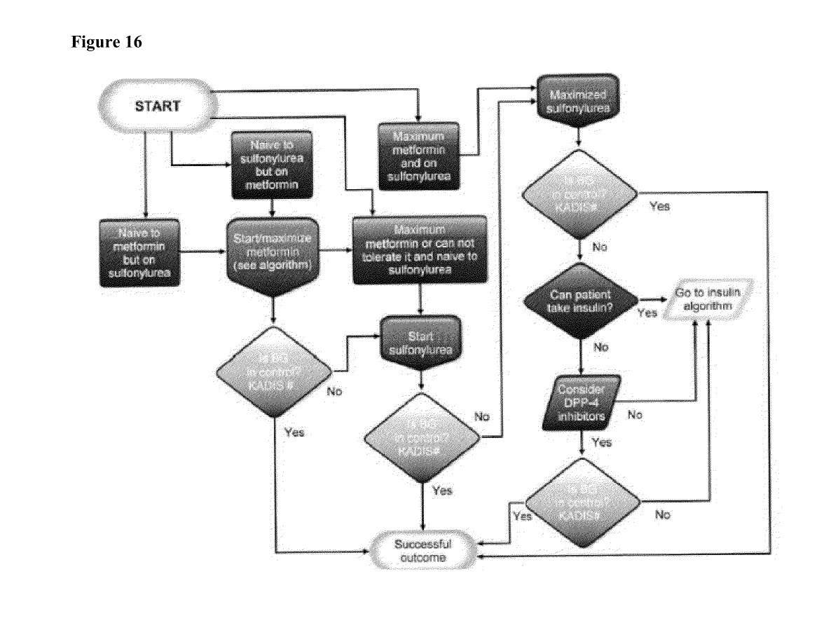

FIG. 17: Meglitinide algorithm.

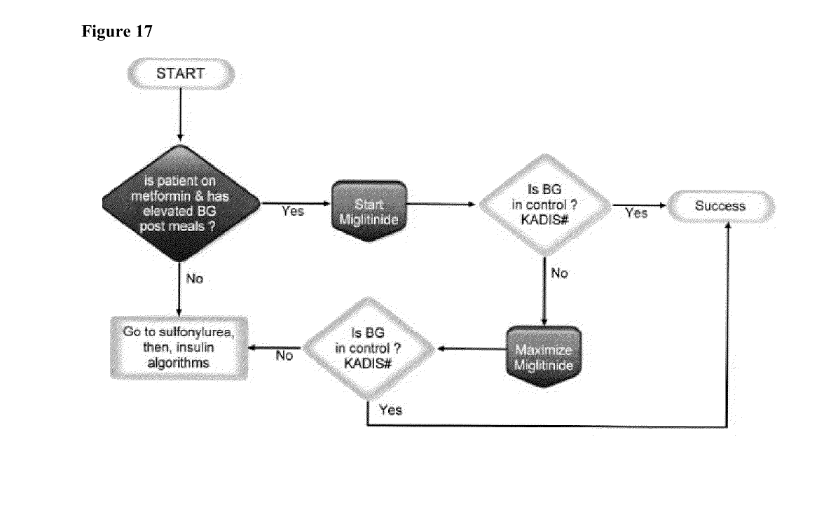

FIG. 18: Insulin algorithm.

FIG. 19: GLP-1 analog algorithm.

FIG. 20: Metformin algorithm.

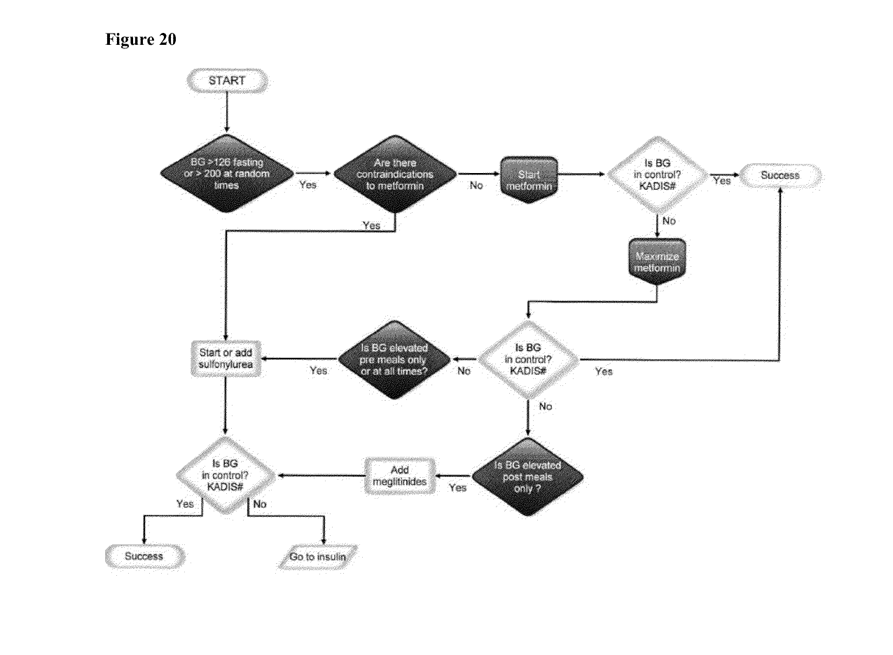

### DETAILED DESCRIPTION

The following description of the invention is merely intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein. All references cited herein are incorporated by reference in their entirety.

Provided herein are novel methods for carbohydrate modeling in subjects with one or more disorders associated with carbohydrate regulation. These methods provide subjects and healthcare providers with real-time or near-real-time feedback on health decisions, thereby allowing for better health monitoring and management of health care decisions. In certain embodiments, the methods may be used by diabetic subjects to provide output health data relating to activities that affect blood glucose levels. Thus, the methods provided herein produce individualized treatment plans for diabetic subjects based on their detailed health information and metabolic fingerprint.

In the methods provided herein, input health data regarding a subject's dietary intake, drug intake, activity level, or other health parameters is entered into a computer system by the subject or a healthcare provider (e.g., a physician) and converted into output health data in the form of health feedback tailored to the subject's current situation. This feedback is displayed on the computer system, and provides the subject and/or the healthcare provider with information for making optimal decisions with regard to various health parameters. In certain embodiments, the input health data is transmitted to a remote server that converts the input health data to output health data. In other embodiments, the input health data is converted to output health data directly on the computer system. Further provided herein are computer systems, including mobile devices, for carrying out the methods disclosed herein, as well as systems that utilize the methods and devices disclosed herein.

In certain embodiments of the carbohydrate modeling methods provided herein, the conversion of input health data to output health data utilizes the Karlsburg Diabetes Management System (KADIS). KADIS is an electronic decision-making support platform for diabetes management that has previously been validated in 538 diabetic patients. Specifically, KADIS has been used previously to predict glucose patterns and insulin requirements based on four inputs: continuous glucose monitoring data, anti-diabetic medications, food log, and exercise levels. The original mathematical model behind KADIS described the glucose/insulin metabolism in type 1 diabetes in the form of a coupled differential equation system (Augstein Diabetes Care 30:1704 (2007). The model was later expanded for application to type 2 diabetes by adding an insulin controller describing basal and glucose-stimulated insulin secretion and therapy with oral anti-diabetic drugs (Augstein 2007). KADIS calculates patient-specific parameters to assist physicians in choosing individual diabetic management regimens for optimizing glycemic control (Augstein 2007). Standard inputs for KADIS include blood glucose levels, drug therapy, carbohydrate intake, and exercise. In those embodiments that utilize KADIS, a diabetic subject enters input health data into a computer system, the input health data is analyzed by the KADIS system, and the subject receives output health data on the computer system in the form of personalized health information or recommendations. In certain embodiments, a physician or other healthcare provider participates in analyzing the input data and/or generating or optimizing output data. KADIS and other systems for generating patient-specific information for controlling blood glucose have not previously been available on a real-time or near-real-time computer platform. Therefore, the methods, devices, and systems provided herein represent a significant improvement over currently available carbohydrate modeling systems by allowing for more immediate behavioral guidance regarding dietary choices, drug administration, and exercise, thereby allowing patients to tailor their activities to current conditions and avoid delays in glucose level management.

In other embodiments, the carbohydrate modeling methods provided herein utilize a platform other than KADIS for converting input health data to output health data. In certain of these embodiments, the methods utilize a platform that allows for fully automated conversion of input health data to output health data, i.e., without input from a physician or other healthcare provider. Since there is currently no fully-automated in silico glucose modeling and patient management system available, this represents a significant step forward. Further, in certain embodiments the methods provided herein do not require continuous glucose monitoring. In certain of these embodiments, the methods utilize the Advanced Diabetes Algorithm Management System (ADAMS) platform developed at the City of Hope National Medical Center. In certain of these embodiments, the platform utilizes fingerstick glucose data rather than real-time glucose monitoring, which is often unavailable or cost-prohibitive.

By designing and implementing a novel, automated paradigm for diabetes treatment, the methods provided herein represent a significant departure from the way healthcare is currently delivered, advancing from a subjective, trial-and-error, and costly physician-centered program to an objective, validated, algorithm-based, data-driven, efficient, and cost-effective therapeutic program. In certain embodiments, information gathered using the methods disclosed herein may be incorporated into one or more databases such as a diabetes registry, and this information may be used to monitor success of various treatment options and thereby improve output data.

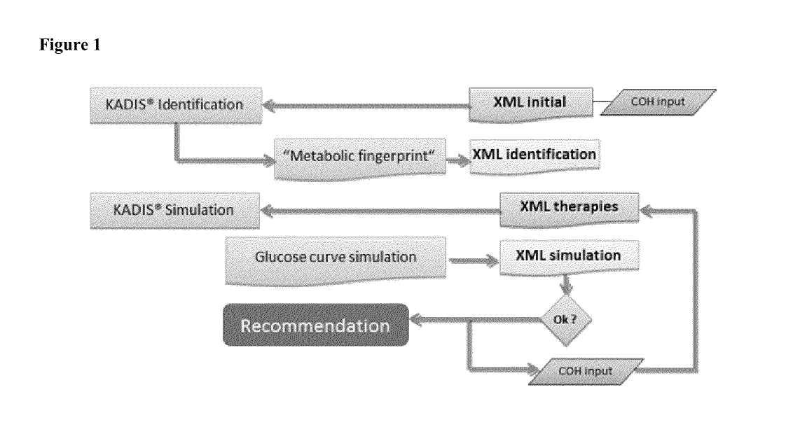

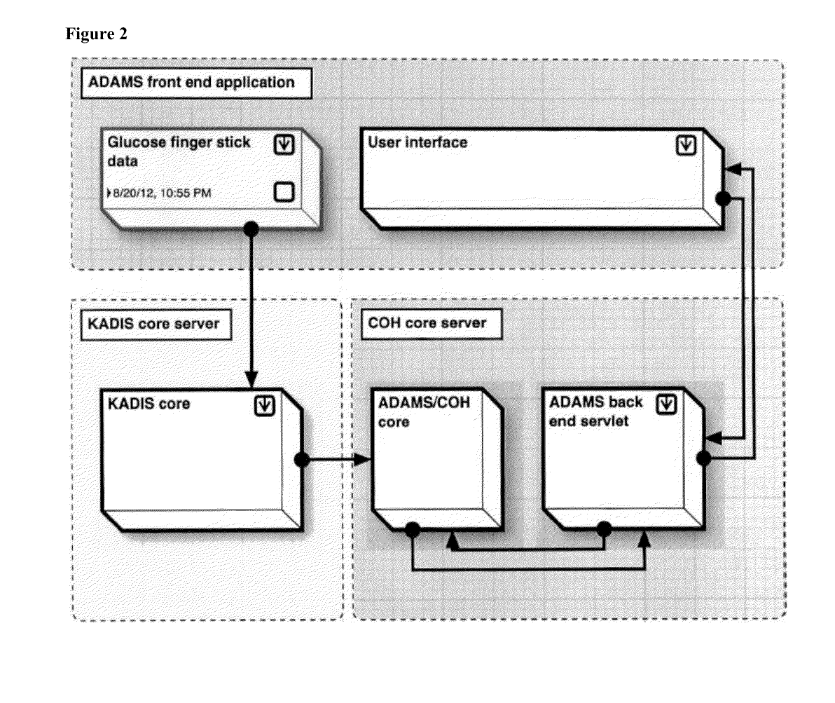

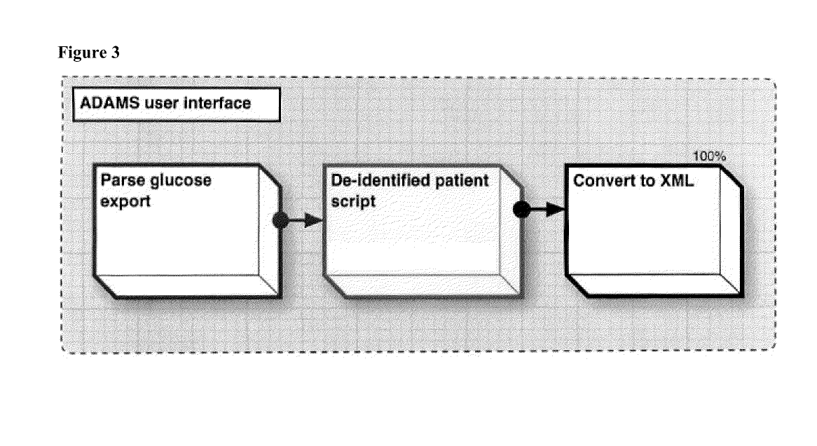

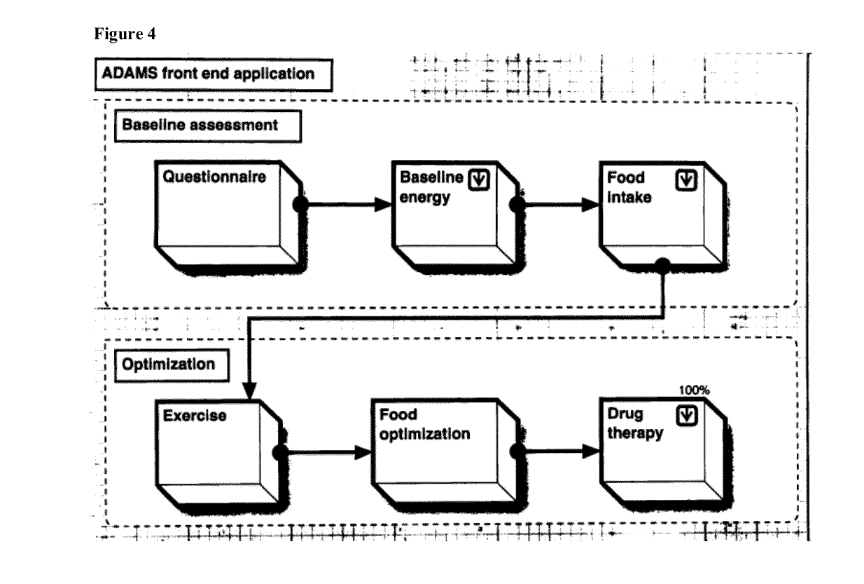

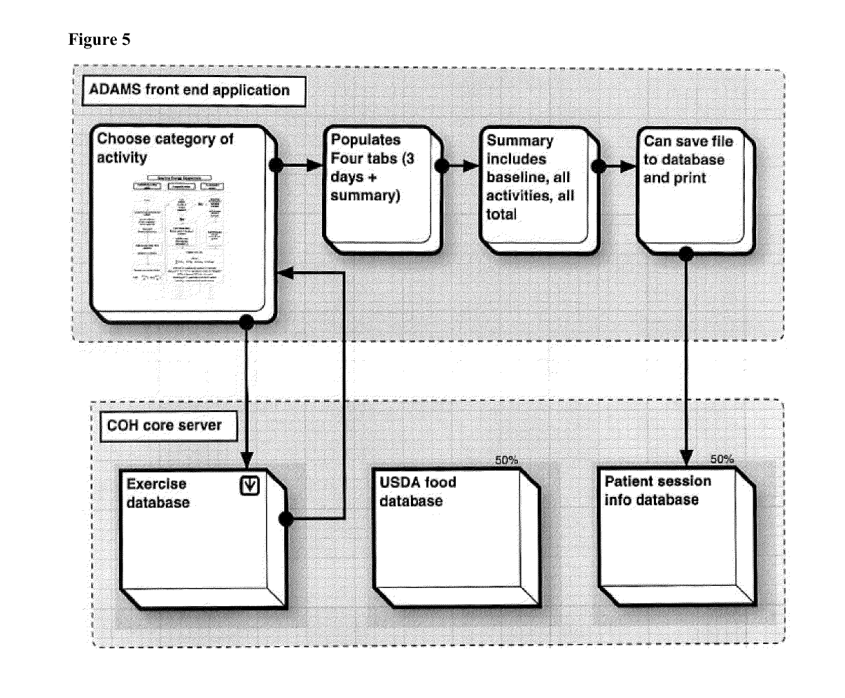

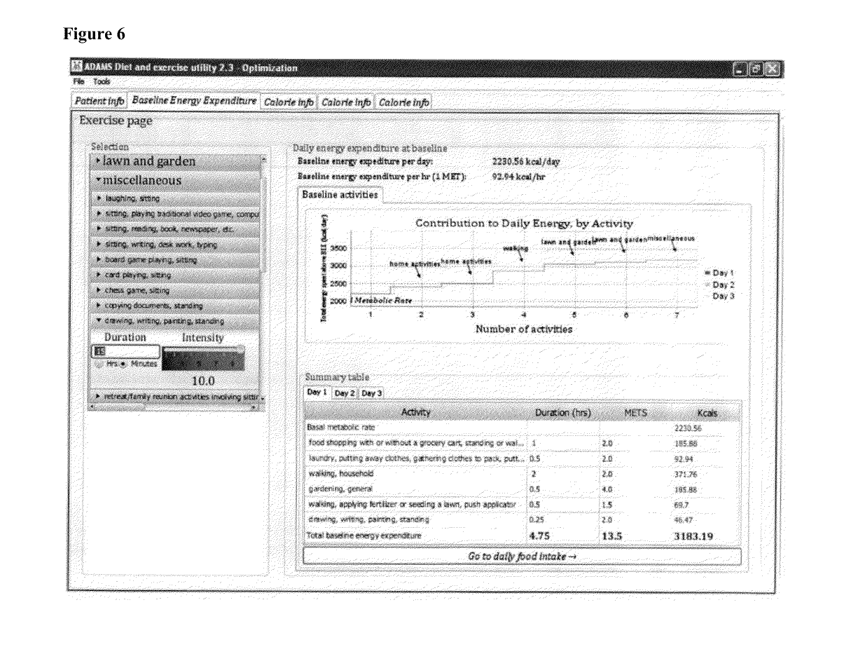

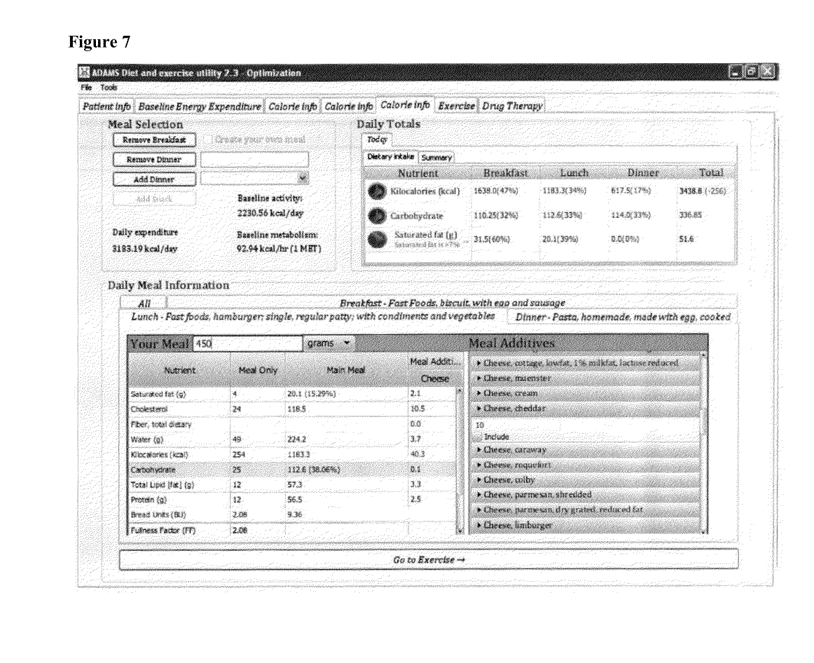

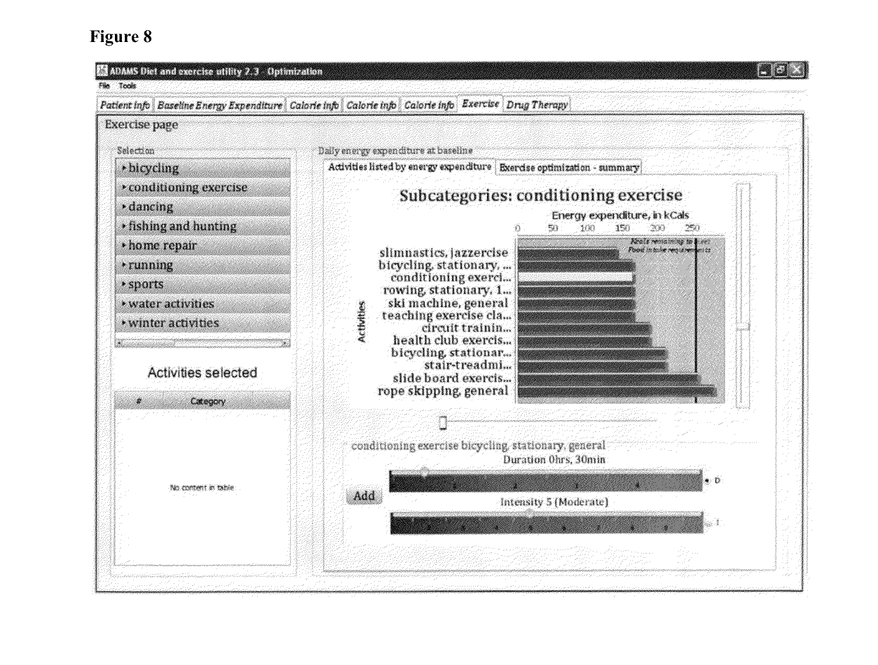

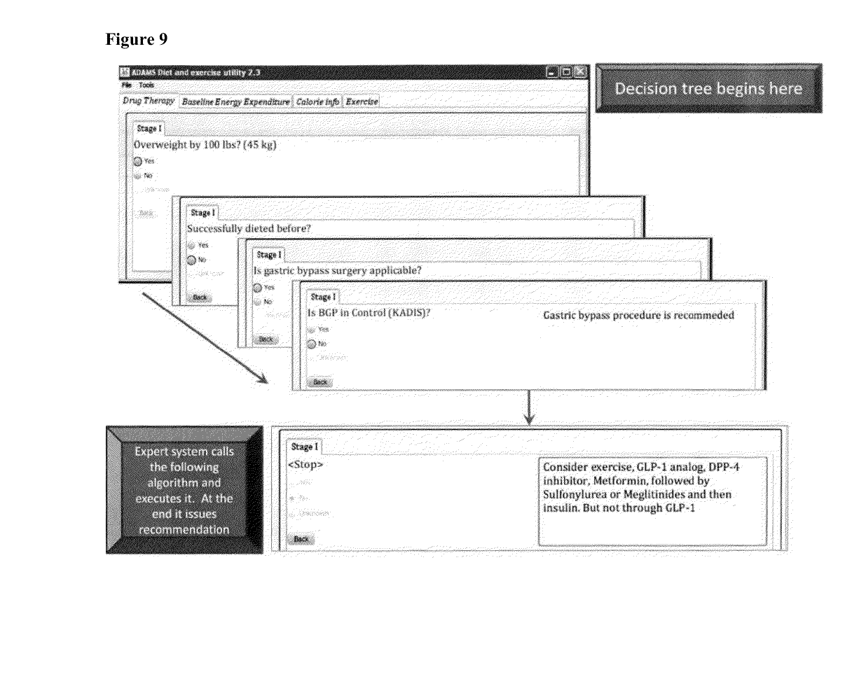

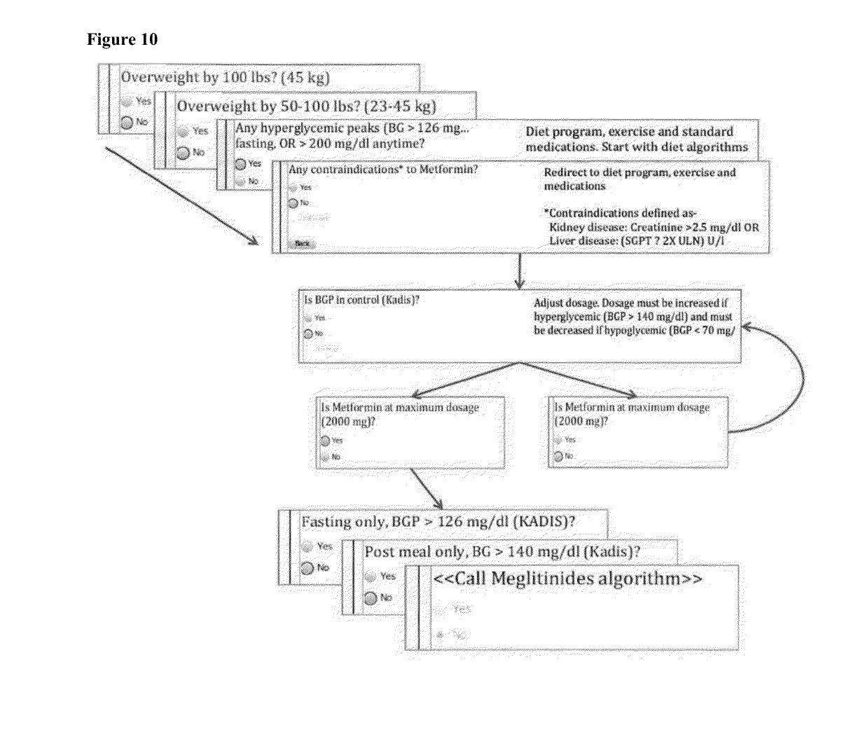

The ADAMS platform consists of multiple components that complement each other in order to fully automate the analysis of physical activity, diet, and carbohydrate metabolism factors in a given patient and generates the most optimal management plan based on these factors. In doing so, the platform utilizes a patient's own historic data, and thus functions as a true personalized electronic decision support system. The components and architecture of the ADAMS platform are illustrated in FIGS. 1-5. The ADAMS platform allows for the use of more detailed, patient-specific, historical, behavioral, physical, and therapeutic data, not only to generate the patient-specific “metabolic fingerprint” and the causally-related “weak point,” but also to determine the order and amount of each treatment element that will be optimally required in the output intervention plan—i.e., the in silico prediction procedure. The ADAMS platform further allows for the generation of a single-output report per patient to provide the best strategy for optimizing blood glucose control, as directed by the entered patient-specific data and the ADA/European Association for the Study of Diabetes (EASD) guidelines-based treatment algorithm, which will assign behavioral modification as the first therapeutic intervention priority, followed by low-cost, highly efficacious and available medications; high-cost or newly introduced medications will be reserved as the last priority. Examples of screenshots generated by ADAMS for dietary, exercise, and other health recommendations are set forth in FIGS. 6-10.

In certain embodiments, the methods provided herein apply an individualized algorithm to the output health data in order to further personalize a subject's feedback. This allows for even greater optimization of glycemic control and resolution of metabolic weak points noted during the in silico prediction procedure. For example, output health data may be personally tailored to conform to a subject's exercise limitations (e.g., health concerns that prohibit a subject from engaging in certain activities), dietary limitations (e.g., local food availability, cultural norms or customs, allergies), or drug limitations (e.g., drug allergies, availability, efficacy, cost). The individualized algorithm may be applied to the output health data on the computer system or it may be applied remotely prior to transmission of the output health data back to the computer system. The individualized algorithm can prioritize treatment recommendations (e.g., drug choices and dosages, nutritional choices, exercise choices, and lifestyle/behavioral modification plans) according to recognized, evidence-based guidelines, as well as current drug availability and cost. This will allow diabetic subjects to take greater control of their health decisions and reduce their dependence on healthcare systems that are inefficient and expensive. In certain embodiments, the algorithm may be modified over time based on changes in the subject's health or the treatment plan.

In addition to providing real-time or near-real-time feedback, the methods, devices, and systems provided herein provide a means for diabetic subjects to develop and maintain a detailed health history, and to have a detailed record of the effect of certain behaviors on glycemic health. By comparing a subject's activities with objective measures such as glucose levels and subjective measures such as energy levels, output health data can be even more precisely tailored over time.

In certain embodiments, a computer system for use in conjunction with the methods and systems disclosed herein is a mobile device, and in certain of these embodiments the mobile device is a multi-use device such as a mobile telephone, tablet, computer, or personal digital assistant. In other embodiments, the mobile device is a limited use device designed exclusively or primarily for use with the systems provided herein.

Input and output health data for use with the methods and systems provided herein may include objective data and/or subjective data. In certain embodiments, input data may be gathered using a set of questions, for example in the form of a questionnaire. A sample questionnaire is provided in Appendix A. Questions may be targeted to a general population, or they may be tailored to a particular patient or patient population. In certain embodiments, input data may be entered on the computer system directly, for example using menus and/or touch screens. Input data may be entered by the subject directly, or it may be entered by another party such as a caregiver or medical professional. In certain embodiments, the data is entered in response to prompts on the computer system, such as a series of questions appearing on the screen. In other embodiments, the data may be entered in response to written or verbal questions. In certain embodiments, questions may be “yes or no” or multiple choice. In certain embodiments, the questions may further require an indication of severity (e.g., on a scale of 1-3, 1-5, etc.).

Examples of objective input data include, but are not limited to, personal and family history information (e.g., date of birth/age, city or country of birth, current city or country, gender, ethnicity (e.g., Hispanic or Latino, Non-Hispanic or Latino), race (e.g., white, Indian or Alaska native, Asian, Black, Native Hawaiian or other Pacific islander), height, current weight, previous weight(s), target weight, education level, occupation, marital status, number of siblings, number of children, or religion), nutrition information (e.g., number and types of meals, number and types of snacks, use of meal replacement supplements, current or past diets and their effectiveness, plans to diet in the future, gastric bypass surgery, eating disorders, frequency of overeating and/or poor food choices, eating associated with stress, depression, or other mood issues, frequency of drinking or smoking, type, dosage, or order of administration of prescription or non-prescription drugs, exercise type, frequency, or duration, impediments to exercise such as pain, injury, physical limitation, travel, or general lack of time), diabetes information (diabetes diagnosis, age of onset, family history of diabetes, frequency and type of glucose monitoring, hospitalization history due to diabetes, serious episodes of low blood sugar, satisfaction with current or previous blood glucose control, issues with blood glucose testing due to mood or other disorders, lack of family support, aversion to needles, or cost, symptoms associated with diabetes, preferred method of controlling diabetes), diabetes medical history for the patient and/or their family (e.g., types and dosages of prescription and over-the-counter drugs for diabetes and other conditions, including for example Metformin, Sulfonylurea, Meglitinides, and DPP-4, vitamin intake, insulin intake, comfort with drug administration, frequency and type of side effects), general medical history for the patient and/or their family (e.g., current and past blood pressure, cholesterol and other lipid and biomarker levels, presence of chest pain or discomfort, heart disease, blood clots, vessel issues such as varicose veins, circulation issues, liver disorders such as hepatitis, gall bladder disease, cancer, joint or other pain, nerve issues such as multiple sclerosis, hormonal disorders, ulcers, numbness in extremities, mood disorders such as anxiety or depression, measles, mumps, rubella, tuberculosis, chicken pox, eye problems, allergies, heart surgeries, amputations, other surgeries, hospitalizations), financial or insurance information (e.g., income level, expenses, employment status, frequency of doctor or hospital visits, health insurance status and information), or other biometric data. Certain types of input data may be sex or age specific. For example, input for a female patient may include questions regarding pregnancy, lactation, menstruation, menopause, birth control, miscarriage, or ovarian or other reproductive organ issues.

Examples of subjective input data may include energy levels or mood. In certain embodiments, the sum of input health data can be converted into a metabolic fingerprint, which provides a snapshot of a subject's health status at a particular time.

In certain embodiments, output data may include compliance reminders (e.g., reminders regarding food or drug intake, exercise, or glucose level measurements) or suggestions regarding health improvement (e.g., food, drug, or exercise suggestions).

In certain embodiments, input and/or output health data can be bundled into one or more modules. For example, a nutritional module may collect input health data relating to dietary intake and provide output health data to improve food selection decisions. A physical fitness module may collect input health data relating to physical activity and provide output health data suggesting specific exercise routines. A diabetes management module may collect input health data relating to blood glucose levels, drug intake, BMI, and other medical parameters relevant to diabetes and provide output health data relevant to those parameters. A hypertension module may collect input health data relating to blood pressure changes and anti-hypertensive agent intake and provide output health data relevant to those parameters. A dyslipidemia module may collect input data relating to levels of various lipids and provide output health data relevant to those parameters.

In certain embodiments, the methods and systems provided herein may utilize a nutritional module. In these embodiments, the subject enters input health data into the computer system in the form of a type and/or brand of food that the subject has eaten or is contemplating eating. This information is searched against a database (e.g., the USDA national food database), and the computer system displays the results of this search as output health data. The search database may be located on the computer system, or it may be located on a remote device connected to the computer system. The results of the search may include basic dietary information about the selected food, e.g., caloric content, carbohydrate count, and/or glycemic index. The output health data may also include alternative food recommendations as well as the dietary characteristics of the recommended foods. In certain embodiments, such food recommendations may be tailored to a subject's specific dietary restrictions or preferences or to the food availability and customs of the region where the subject is located. Such a dietary module will encourage compliance with recommended dietary plans by providing automated feedback tailored to the subject's specific situation and tastes and by offering positive feedback regarding dietary choices.

In certain embodiments, the methods and systems provided herein may utilize a physical fitness module. In these embodiments, the subject enters input health data into the computer system in the form of information about recent or planned physical activities. This information is searched against a database (e.g., the 2011 Compendium of Physical Activities), and the computer system displays output health data in the form of metabolic equivalents associated with the subject's physical activity or recommendations regarding alternative or additional physical activities. In certain embodiments, these physical activity recommendations may be tailored to a subject's specific physical limitations, exercise capacity/tolerance, or past exercise activities. In certain embodiments, the physical fitness module may also provide general information regarding physical fitness and its impact on short- and long-term health.

In certain embodiments, the methods and systems provided herein may utilize a diabetes management module. In these embodiments, the subject enters input health data into the computer system in the form of information such as blood glucose levels, drug therapy (including insulin intake and intake of other hypoglycemic agents, body mass index (BMI), past medical history, and current associated medical conditions that may influence the choice of treatment options as input health data. In these embodiments, the input health data may be converted into a metabolic footprint. The computer system displays output health data in the form of specific dietary, exercise, or drug recommendations. In certain embodiments, the methods will take into account a subject's profile over a specific timeframe when generating output data. For example, the methods may utilize information collected over a 12 hour or 24 hour period or over a specific number of days to determine glucose patterns, including the glucose target range, diurnal changes in insulin sensitivity, action profiles of endogenous and exogenous insulin, time and dosage of exogenous insulin administration or oral hyperglycemic agents (OHAs), and the related action profile; time and dosage of meal intake and the related resorption profiles; and exercise (if performed). Utilization of information generated over a specific time period allows the systems to identify weak points that indicate the relationship between a particular endogenous or exogenous factor and deterioration in metabolic control.

In certain embodiments, the methods and systems provided herein may provide output data in the form of compliance recommendations or reminders. In certain embodiments, these recommendations or reminders may be based on specific input data. In other embodiments, the recommendations or reminders may be based on an overall long-term treatment strategy rather than on specific input data. For example, the systems may provide compliance reminders regarding recommended dietary intake, scheduled drug intake, recommended physical activity, or blood glucose measurements.

In certain embodiments, the methods and systems provided herein may utilize a text-only format for input and/or output health data. In other embodiments, the methods and systems may utilize a graphical interface that allows subjects to enter input health data or view output health data in graphical format (e.g., using icons or symbols). In certain embodiments, the methods and systems may use a combination of graphical and text formats for input and output health data. In those embodiments wherein the systems employ one or more modules, the systems may employ a different icon for each module. Within the modules, there may be a set of icons or photographs that allow the subject to enter input data. For example, a nutritional module may contain a set of icons or photographs corresponding to different types of food. Output health data may likewise be displayed in graphical format. The use of graphical interfaces or partial graphical interfaces rather than text-only interfaces makes data entry more efficient by reducing the amount of typing necessary. Graphical interfaces also allow for the methods and systems provided herein to be used by subjects speaking a variety of languages, as well as by illiterate subjects. In certain embodiments, the methods and systems provided herein may utilize a voice interface that allows subjects to enter input data and receive output data in voice format, allowing for use of the methods and systems by subjects with vision impairment.

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention. It will be understood that many variations can be made in the procedures herein described while still remaining within the bounds of the present invention. It is the intention of the inventors that such variations are included within the scope of the invention.

### EXAMPLE 1

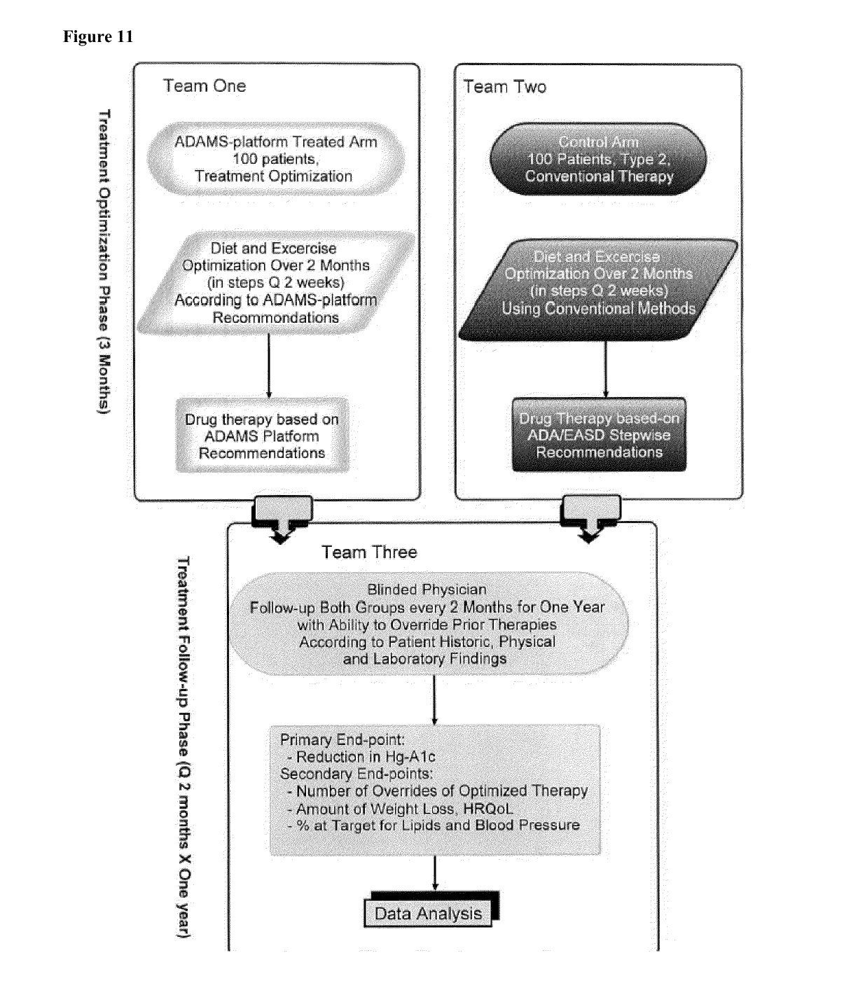

A randomized, double-masked (patients and long term follow-up team) trial will be carried out to compare ADAMS to standard care at City of Hope. The primary outcome is the change in HbA1c from pre-treatment to post-treatment, with average post-treatment HbA1c as a secondary outcome. The primary planned analysis will compare the ADAMS group to the control group, as randomized, with regard to mean decline in HbA1c. The decline is HbA1c will be calculated for each subject as the mean of all post-treatment evaluations minus the baseline evaluation. The two groups will be compared using a two-sided Welch t-test, which allows for possible difference of variance in the two groups. The study protocol is outlined in FIG. 11.

Two groups of 50 adult patients each with type 2 diabetes and balanced for age, gender, duration of diabetes, Body Mass Index, and self-reported physical activity score will be studied. No patient will have excessive body weight for height (using the Metropolitan Life tables for Height-Weight, adjusted for body frame; 1983) by more than 50 lbs (patients with more than 50 lbs excess body weight will be treated with different therapeutic algorithms that prioritize bariatric surgery and the use of incretin hormones based on the degree of obesity and prior history of successful weight loss, and therefore they will not be included in this study). No attempt will be made to balance patient groups for hypertension or hyperlipidemia beyond the balancing effect of randomization. However, all patients will be free of significant liver disease (liver enzymes no more than twice the upper limit of normal), renal disease (serum creatinine no more than 1.5 mg/dl), or active coronary disease. Patients will be recruited from those already attending the diabetes clinic at City of Hope and those who are newly applying for diabetes care. No patient with active malignancy will be included; if he/she has had a history of cancer therapy, the patient will had to have been cancer-free for a minimum of 5 years.

Randomization will be performed by central telephone registration of patients, after consent, onto a pre-prepared randomization log, held in confidence by the registrar. Because both types of management have access to the same therapeutic choices, there is no need for emergency unmasking. Expected mean results for planning are given in the table below.

| | Mean | Mean Post- |
|---|---|---|
| | Baseline HbA1c | Treatment HbA1c |
| ADAMS group (Group 1) | 8 | 6.5 |
| Standard of care group | 8 | 7.5 |
| (Group 2, Control) | | |

The mean HbA1c percentages are expected to be essentially equal for the two groups at baseline, due to randomization. A modest decline is expected in the control group, as standard care at COH is expected be somewhat more effective than that received leading up to the baseline measurement. A further improvement of a full percentage point on the ADAMS arm would represent a clinically important advance that we regard as achievable.

Each patient group will be managed by a separate medical team, each consisting of a diabetologist, a certified diabetes nurse educator, a nutritionist, and a physical therapist. One medical team will use the ADAMS platform output to recommend physical activity, dietary modifications and drug therapy, and the other medical team will use standard practice to provide the treatment recommendations for adjustments in physical activity, diet and medication adjustment. Patients in both groups will undergo the same baseline evaluation and will not know by which method the treatment recommendations were established.

The ADAMS front end program functions as a data collection and presentation layer for the decision-support system. Subjects are given electronic tablets to log diet and exercise information for a later use in calculation of baseline physical activity and dietary intake, as well as for optimization of physical activity and dietary management by the electronic ADAMS platform for Group 1 and by the dietician for patients in the standard of care group of the study. The ADAMS program display is arranged sequentially in tab format, including tabs for patient information, physical activity and exercise, food intake, and drug therapy. Processing of data is accomplished using a 3-tiered architecture: the client tier contains the ADAMS front-end component, which consists of the user interface (presentation layer), application logic, and data retrieval classes. The application server (2^{nd} tier) contains the business logic and data access layer, and the 3^{rd} tier contains the information server. A single stand alone application which contains the user interface, application logic, and an embedded database will be made available where internet access is not available. Servers for application and information tiers are hosted through the clinical information system (CIS) department at City of Hope, and the data collection subset of the ADAMS front-end program will be made available for downloading on an applicable patient computer or assigned electronic tablets through the website. Patients who are not comfortable with computer use will be assigned paper data collection tools. Appendix 1 shows several screen shots of the diet, physical activity, and drug therapy using expert system technology.

Baseline Assessment:

Each patient will be provided with an electronic questionnaire designed to obtain detailed personal and family background information, medical history information, diabetes care information, previous eating habits, weight loss patterns, amount and frequency of physical activity, financial histories, and other study related data elements, in order to adapt to patient-specific limitations, restrictions and preferences. Form data are then passed to the information server following the initial user authentication through the application server.

Questions are divided into eight domains: personal and family history, general medical history, diabetes disease history, diet history, exercise history, medications history, social history and financial history. Questionnaires will be made available to patients through a secure web-page, electronic tablets or paper format. Diabetes educators will assist the patients with the completion of information and will attempt to verify the accuracy of data. A subset of the information gathered will be utilized to generate the data required for metabolic finger-print analysis by the KADIS® program, while another subset of information will be utilized in guiding the selection of treatment options. A third group of data will be used for the correlation with and/or interpretation of outcome data.

Patient-specific data such as age, gender, weight, height, body mass index (BMI) and Basal metabolic rate (BMR), metabolic equivalent (MET), type of diabetes and baseline HgbA1c will be populated into the patient information page of the front-end ADAMS program. BMR is calculated using the patient's weight, height, age, and gender as follows for men and women:

(4.53×weight (lbs))+(15.88×height (in))−(4.92×age (yrs))+5 Men:

(4.53×weight (lbs))+(15.88×height (in))−(4.92×age (yrs))−161 Women:

To account for the thermic effect of food consumption, the initial BMR calculations are multiplied by a factor of 1.2 to obtain the thermic BMR (tBMR). We then define the basal kCals/hr which is equal to 1 MET for the patient by dividing the tBMR by 24, and convert all METs expended for baseline physical activity into calories.

Each patient will be evaluated for baseline state of health and absence of diabetes complications and related health problems, including but not limited to hypertension, diabetic eye disease, neuropathy, nephropathy, and atherosclerosis. In order to obtain an accurate measurement of objective parameters related to these conditions, specific established tests will be performed including fundus photography, peripheral nerve conduction studies, and carotid artery intimal thickness. Nephropathy will be assessed based on spot urine microalbumin excretion and MDRD estimation of GFR using patient gender, race, age, serum creatinine and BUN.

A comprehensive metabolic panel, CBC, urine microalbumin excretion, lipid panel, thyroid function and HbA1c panel will be performed at the outset of the study. HbA1c will be measured on visits 1 and 2 and the average of these two measurements will be used to determine the magnitude of change in HbA1c during treatment.

Blood samples will also be collected, processed, catalogued and stored at −80 degree C. for measurement of other serum, plasma, and cellular biomarkers, such as the emerging epigenetic markers of metabolic memory (H3K9me3), vascular inflammation (miR-200), diabetic renal disease (miR-192), insulin resistance, obesity and endoplasmic reticulum (ER) stress (miR-26a), and genome-wide accelerated inflammation (transcription factors PU.1 and C/EBP-alpha.

A database containing physical activity information is compiled based on the 2011 Compendium of Physical Activities. Initial baseline physical activity is assessed using an expanding, tile-based list of physical activities, arranged by category, and is used to calculate patient daily physical activity and corresponding caloric expenditure. Selecting a category expands a sub-list of individual activities pertaining to the current category. Once the user selects an activity, the individual tile expands to show controls to measure duration that the patient engaged in the selected activity (entered as hours or minutes), as well as an adjustable gauge of intensity, given on a scale from 1 to 10. Each entry is logged in a visible 4-column table which records activity name, duration, metabolic equivalents (METs), and kCals for each activity. The cumulative amounts for the latter 3 columns are shown, and the individual and cumulative amounts of kcal/day for all activities are shown in a stepwise graph. The duration of each activity is factored to give the total kCals over the reported activity period. The kCals are also adjusted for each activity based on the patient's estimated level of intensity, which gives 100% of the reported kCals for the highest intensity level, and 10% of the reported kCals for the lowest intensity level.

Multiple formats are available for entering meal data, including electronic or paper form submission, or by direct data entry to the ADAMS client. If necessary, electronic tablets will be assigned to patients to use for keeping daily logs which can then be submitted electronically for review. Patients unable to use a tablet or computer will be provided with 3 day paper logs, which will be reviewed by the physician/dietitian before information is entered into the ADAMS database by program dieticians. To enter daily food intake using the ADAMS client program, the user types a food name into the search box for each meal. The auto-complete algorithm generates a query of the USDA national food database using foods matching the user entry. Once a food selection and amount is entered from the drop down list of associated foods, a query returns the reported nutritional data for the selection. Food additives such as butter, cheese, etc. can also be entered to specify the meal. The total daily food intake is then used as an initial assessment of the required physical activity for the patient. USDA food data accessed and modified meal entries saved for each patient through the CIS server or through the ADAMS embedded database.

Once baseline assessment is completed, a sub-set of the data that includes patient age, type and duration of diabetes, weight and height, baseline blood glucose measurement (3-day continuous glucose monitoring records or appropriately validated multiple blood glucose daily measurements), currently used anti-diabetes medications, time and quantities of caloric intake (estimated in bread units) and exercise level are communicated to the KADIS program for generating baseline metabolic fingerprint analysis and KADIS program output (called identifications) for use in the metabolic simulations in the KADIS application so that a daily profile of blood glucose in relation to targets, endogenous insulin secretion and daily variation in insulin sensitivity, exogenous insulin intake and insulin equivalent effects of oral agents, daily meals and other caloric intake and exercise related metabolic effects.

Treatment Optimization Phase:

The six months following completion of baseline evaluation and randomization to the treatment groups will be considered the Treatment Optimization Phase, in which patients in both groups will interact with their respective medical teams at the same frequency (face to face interactions and telephone follow-up calls), and will receive an equal number of recommendations for physical activity, diet and drug therapy changes (as outlined in Table 1, below). Patients in the ADAMS group, will receive their drug therapy recommendations primarily based on those recommendations generated by the system, with the possibility for override by the treating physician based on patient safety concerns, whereas patients in the standard-of-care arm will receive drug changes/recommendations based on clinical judgment only.

TABLE 1
Schedule of visits during treatment optimization phase of study (6 months)

| | Visit 1 | Visit 2 | Visit 3 | Visit 4 | Visit 5 |
|---|---|---|---|---|---|
| Time from | 1-2 weeks | 3-4 weeks | 8-10 weeks | 16-18 weeks | 24-26 weeks |
| randomization | (baseline) | (1-2 weeks) | (5-6 weeks) | (6-8 weeks) | (6-8 weeks) |
| (Duration | | | | | |
| between visits) | | | | | |
| ADAMS | Baseline | Physical | Drug | Adjustment | Adjustment |
| (Group 1) | data & | activity & | therapy | in physical | in physical |
| | clinical | diet changes | changes if | activity, diet | activity, diet |
| | evaluation | Drug | was not done | or drug | or drug |
| | | therapy | on visit 2 | therapy, as | therapy, as |
| | | changes if | | needed | needed |
| | | possible | | | |
| Standard of | Baseline | Physical | Drug | Adjustment | Adjustment |
| Care | data & | activity & | therapy | in physical | in physical |
| (Group 2) | clinical | diet changes | changes if | activity, diet | activity, diet |
| | evaluation | Drug | was not done | or drug | or drug |
| | | therapy | on visit 2 | therapy, as | therapy, as |
| | | changes if | | needed | needed |
| | | possible | | | |

Follow-up phone calls, primarily by the diabetes educators, will be attempt after institution of drug therapy

Optimization of Exercise Level: Patients who are randomized to the standard of care group will be assessed for physical fitness by physical therapists using patient exams and patient self-ratings of baseline physical activity score developed by Jurca and colleagues, and a routine exercise prescription will be given. For patients who are randomized to the ADAMS platform, exercise prescriptions will be generated based on exercise optimization program output. In this case, target levels of energy expenditure will be estimated based on a previously described method for estimating metabolic equivalents by measuring cardiorespiratory fitness associated with gender, age, BMI, resting Heart Rate (HR), and self-rating physical activity score.

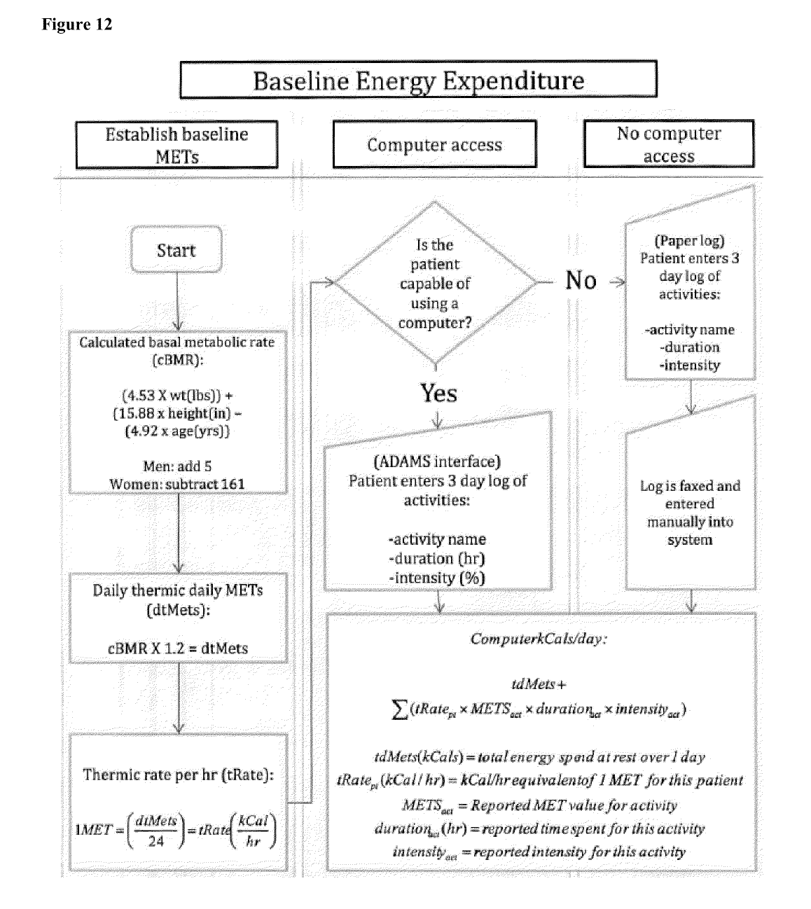

The target daily exercise-energy expenditure is defined by reducing maximal METs level of cardiorespiratory fitness by 10% for each level of self-reported physical activity below 5, or by reducing desirable heart rate for exercise (maximum exercise-induced heart rate—age) for patients who are physically unfit by 25% for <40y, 40% for those between 40 and 60y, or by 50% for >60y. In all cases, patients who had previous history of coronary disease and those who are treated with beta-blockers will require cardiac evaluation and exercise recommendation by the treating cardiologist. Once target daily exercise-METs are determined, it can then be converted to the equivalent kCals per day. If the daily caloric intake from food exceeds the total target daily energy expenditure (desired exercise-related energy expenditure+BEE adjusted for food intake), then daily caloric intake will need to be cut down (see below). Once an exercise target for energy expenditure is determined, a patient chosen category of exercise is selected which will then show a list of corresponding individual activities that are ranked by energy expenditure level. The selected list of exercises and target energy expenditure is displayed on a horizontal bar graph. Horizontal bars for each activity representing associated kCals are shown with a vertical threshold line defining the target energy expenditure, and a slider interface for changing the duration of activity is provided. By changing the “hours of activity” slider, the energy requirement bar shifts relative to each activity, so that it dynamically determines the time needed for a given exercise to reach the target caloric expenditure. An exercise summary table is also populated which shows the energy contribution for multiple activities combined with preexisting baseline physical activities, relative to the desired total daily caloric expenditure, including food intake-adjusted BMR (tBMR). A summary of the flowchart for calculating baseline energy expenditure is set forth in FIG. 12.

Optimization of Dietary Intake: Similar to the optimization of daily exercise, nutritionist will review baseline food intake and recommend the necessary dietary modifications which will be given to patients in the standards of care group. For patients who are in the ADAMS platform-treated group, recommended diet modifications will be determined by the program out-put using an expert system function to optimize total carbohydrates, saturated fats, and meal distribution. The expert system flags the area of optimization with a caution graphic within the summary table, and suggests meal alternatives based on the specified dietary deficiency or excess after accounting for the recommended exercise. The total caloric intake is defined as excessive if it is >10% of the total calories burned through exercise and baseline physical activity and recommended daily exercise. The algorithm then evaluates the total carbohydrates by suggesting meal modification if the CHO is >65% of the total daily calories. Grams of carbohydrates are converted to kCal with the equation, 1 g CHO=4 kCals of energy. Next the total % of saturated fat is evaluated, where >7% of the total daily caloric intake is defined as excessive. Saturated fat is converted to kCals with the equation, 1 g SF=9 kCal of energy. The algorithm then flags meals which represent >40% of the total daily calories, and suggests meal redistribution.

Metabolic Simulation: Once desired daily exercise and daily meal intake are optimized, KADIS simulation (application) is then run to assess the degree of improvement in patient glycemic control. If patient metabolic control is found to be optimal with diet and exercise modifications only, then no drug therapy will be recommended. However, if blood glucose optimization in silico is found to be less that 90% of target, then the expert system will call the drug treatment algorithms and apply them.

Drug Therapy Optimization: Once the physical activity and diet are optimized and the metabolic control of the patient is simulated and found to be at less than 90% of target, the expert system will access the drug treatment algorithms and apply them until blood glucose optimization in silico of 90% is reached or exceeded. Application of the drug therapy algorithms will be carried out in the following sequence, guided by patient preferences, drug effectiveness in reducing blood glucose, presences or absence of medical conditions that limit the use of specific therapeutic agents, drug side effects in a given patient, and drug cost:

Metformin Algorithm: Metformin will be used as a first-line drug therapy. It is widely accepted as a very effective therapeutic agent with safety records of over fifty years. Its use is associated with modest weight loss. Its major action is reduction of hepatic glucose production, in addition to a modest insulin-sensitizing effect. It may also have anti-cancer effects. Metformin will be used in daily doses of 500 to 2000 mg. A 500 mg dose will be given once with timing dependent upon the highest daily glucose excursion. Patients with high fasting glucose but not elevated blood glucose at other times of the day will receive a single dose of metformin at dinner or before bedtime, while patients with elevated blood glucose at more than fasting will receive two to four doses depending on the timing of blood glucose excursion.

Sulfonylurea Algorithm: The sulfonylurea class of drugs has also been available for over 50 years, and newer second-generation agents have relatively fewer side effects. They act by enhancing insulin secretion and are usually very effective in earlier phases of diabetes when islet cells remain responsive to secretagogues. Side effects associated with these agents include weight gain and risk of hypoglycemia. Sulfonylureas will be used as second-line agents as an adjunct to metformin for patients with blood glucose that could not be controlled adequately with the use of metformin alone. They also will be used as a replacement first-line therapy in patients who cannot tolerate the side effects of metformin, those with advanced renal or hepatic disease, or are greater than 75 years of age (these patients will not be eligible for this study). Sulfonylureas will be given once or twice per day based on magnitude and timing of blood glucose excursions.

Miglitinide Algorithm: Miglitinides also are another insulin secretagogue class of medications that act through binding to the sulfonylurea receptor, but generally have a shorter duration of action than sulfonylureas. They are also more expensive than sulfonylureas. Their use will be limited to patients with postprandial hyperglycemia only that cannot be eliminated successfully by metformin or sulfonylureas. They may be combined with metformin, but not sulfonylureas.

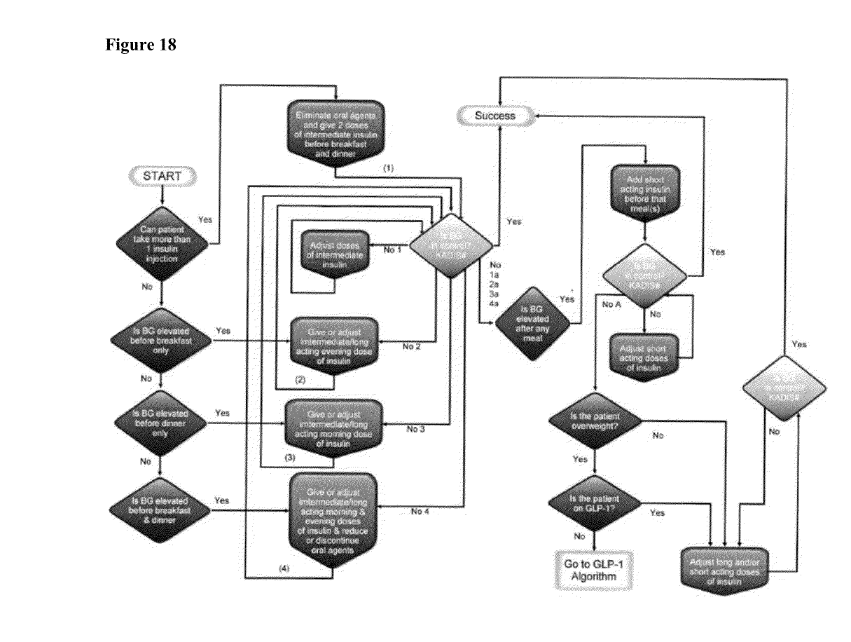

Insulin Algorithm: Patients with blood glucose that could cannot be controlled with the above oral agents and do not object to the use of insulin will be started on insulin therapy either in addition to oral or instead of the above oral agents depending upon whether the patient can take one or more injections per day. Intermediate-acting and regular insulin will be the initial agents used for their lower cost. Longer-acting insulin will be reserved for patients who do not wish to take more than one injection per day and would not be adequately controlled by the use of intermediate-acting insulin. Similarly, use of short-acting insulin will be reserved for individuals with postprandial elevation in blood glucose that cannot be controlled with metformin or miglitinide and those needing long-acting insulin that have post meal glucose excursions. An example of an algorithm for optimizing insulin administration is set forth in FIG. 18.

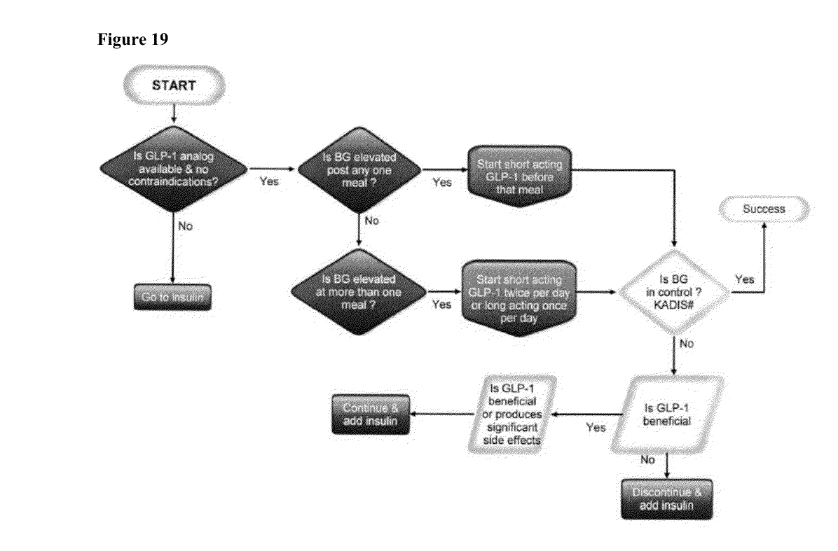

DPP-4 Inhibitors/Incretin Algorithm: DPP-4 inhibitors and incretin hormone analogues will be used as a last line of therapy based on their higher cost. DPP-4 inhibitors will be used in patients who are not controlled on other oral hypoglycemic agents and do not wish to start on insulin. Incretin analogues will be used in conjunction with oral agents or alone in patients who are overweight or who have hypoglycemic tendencies. DPP-4-inhibitors extend the action of meal-induced endogenous GLP-1 and other incretin hormones, whereas incretin analogues potentiate glucose-stimulated insulin secretion, inhibit glucagon secretion, slow gastric emptying, and enhance satiety. The latter actions usually cause a modest amount of weight loss. An example of an algorithm for optimizing GLP-1 administration is set forth in FIG. 19.

Follow-Up Phase:

At the conclusion of the 6-month Treatment Optimization phase, the care of patients in both treatment groups will be transferred to a third medical team composed of the same clinical members as described for the first two teams, who will be blinded to the assignment of patients to the optimization groups. During the Follow-Up Phase, the third medical team will provide routine diabetes medical care to all patients on a bimonthly schedule for one year, and will have total freedom to adjust physical activity, diet and drug therapies as members of this medial team feels necessary to ensure optimal patient care.

Physical assessment: Follow-up physical assessment will be conducted at each visit. However, specialized objective tests will only be done at 6 and 12 months of the one-year follow-up period. These will include: fundus photography, peripheral nerve conduction studies, and carotid artery intimal thickness. Nephropathy will be assessed based on spot urine microalbumin excretion.

Laboratory assessment: This will include comprehensive metabolic panel, CBC, microalbumin excretion, lipid panel, and HbA1c. These tests will be done at 2-, 4-, 8- and 12-month visits and will be used for the comparison with the respective baseline values as well as for the comparison between the two treatment groups.

Biological samples archive: Blood samples, similar to those obtained at the baseline time will be collected, processed, cataloged and stores at −80 degrees C. for measurement of other serum, plasma and cellular biomarker. These samples will be collected at 6 and 12 months of the follow-up period.

Secondary analyses will address (1) the actual differences in patient management between ADAMS and standard care groups, (2) the differences in cardio-respiratory fitness score and weight change between the two treatment arms, and (3) the extent to which fitness and weight change mediate the differences between arms in blood pressure, lipid profile, and HbA1c changes. Differences in patient management will be summarized as changes to the type and amount of medications, changes in exercise recommendations, and changes in diet. Fitness score and weight change will be summarized graphically, with numerical summary of initial and final values, and changes. Confidence intervals and t-statistics will be used to support inferences. The role of fitness, weight change, and change in medications as mediators of effect on HbA1c, BP, and lipid levels will be addressed as an essentially observational question within this experimental study. General linear model methods and modern regression methods (e.g. multivariate adaptive regression splines and classification and regression trees) will be used to identify ranges and combinations of values of intermediary variables that predict a benefit. These might serve as composite targets of therapy for future evaluation.

As stated above, the foregoing is merely intended to illustrate various embodiments of the present invention. The specific modifications discussed above are not to be construed as limitations on the scope of the invention. It will be apparent to one skilled in the art that various equivalents, changes, and modifications may be made without departing from the scope of the invention, and it is understood that such equivalent embodiments are to be included herein.

What is claimed is:

1. A method for the control and treatment of diabetes in a subject in need thereof comprising:
a) entering one or more pieces of input health data for the subject selected from the group consisting of dietary data, physical activity data, and drug intake data into a computer system;
b) converting the input health data into output health data;
c) displaying the output health data on the computer system, wherein the output health data provides one or more health recommendations selected from the group consisting of dietary recommendations, physical activity recommendations, and drug intake recommendations.

2. The method of claim 1, wherein said conversion of input health data into output health data is carried out using the Karlsburg Diabetes Management System (KADIS).

3. The method of claim 1, wherein said conversion of input health data into output health data is carried out using the Advanced Diabetes Algorithm Management System (ADAMS).

4. The method of claim 1, wherein the computer system comprises a mobile device.

5. The method of claim 4, wherein the input health data is converted to output health data on the mobile device.

6. The method of claim 1, wherein the input health data is converted to output health data on a remote server wirelessly connected to the mobile device.

7. A mobile device for use in the method of claim 1.
